(19) United States
(12) Patent Application Publication
(10) Pub. No.: US 2019/0127148 A1
(43) Pub. Date: May 2, 2019

(54) System and Methods for Automated Storage Receptacle Processing

(71) Applicant: Walmart Apollo, LLC, Bentonville, AR (US)

(72) Inventors: Timothy J. Burleson, Bentonville, AR (US); Andrew B. Millhouse, Gilbert, AZ (US); Jacob R. Schrader, Sterling, IL (US); Jeffery Alan Ward, Casa Grande, AZ (US)

(21) Appl. No.: 16/179,610

(22) Filed: Nov. 2, 2018

Related U.S. Application Data
(60) Provisional application No. 62/580,668, filed on Nov. 2, 2017.

(51) Int. Cl. B65G 1/137; B25J 13/06

(52) U.S. Cl. CPC B65G 1/1373; G06F 3/04842; B25J 13/06

(57) ABSTRACT

Described in detail herein are systems and methods for automated storage receptacle processing. Sensors, disposed with respect to storage receptacles scan the storage volume of a storage container and detect physical objects disposed in the storage volume of the storage receptacle. The sensors can determine an amount of unoccupied space in the storage volume of the storage receptacle and transmit an indication of the determined unoccupied amount of space to a computing system. The computing system can calculate a percentage of occupied storage volume in the storage receptacle and transmit a command to control the operation of a motor of the door at which the at least one storage receptacle is disposed based on the calculated percentage. The computing system may also be configured to transmit a message to a vehicle tasked with moving the storage container based on the determined amount of unoccupied space.

### CROSS-REFERENCE TO RELATED PATENT APPLICATION

This application claims priority to U.S. Provisional Application 62/580,668 filed on Nov. 2, 2017, the content of which is hereby incorporated by reference in its entirety.

### BACKGROUND

Distribution centers or other large facilities frequently contain multiple delivery bays to which a container or other storage receptacle may be transported for loading and unloading. The loading bays may each be equipped with a door. For example, a distribution center may contain multiple loading bays which received multi-model containers delivered by truck. Once delivered to the loading bay the storage receptacle is loaded or unloaded as required. Operation of the facility requires scheduling the transport of the storage receptacles and opening and shutting of the doors based on the progress of the loading and unloading operations.

### BRIEF DESCRIPTION OF DRAWINGS

Illustrative embodiments are shown by way of example in the accompanying drawings and should not be considered as a limitation of the present disclosure:

FIG. 1A is a block diagram of storage receptacles storing physical objects in a facility in accordance with an exemplary embodiment;

FIG. 1B is a block diagram of a door in a loading dock in a facility in accordance with an exemplary embodiment;

FIG. 2 illustrates a user interface of a remote device in accordance with an exemplary embodiment;

FIG. 3 is a block diagram illustrating an autonomous robot device according to exemplary embodiments of the present disclosure

FIG. 4 is a block diagram illustrating an automated storage receptacle system processing according to exemplary embodiments of the present disclosure;

FIG. 5 is a block diagram illustrating of an exemplary computing device in accordance with exemplary embodiments of the present disclosure; and

FIG. 6 is a flowchart illustrating an exemplary process in accordance with exemplary embodiments of the present disclosure.

### DETAILED DESCRIPTION

Described in detail herein are system and methods for automated storage receptacle processing in a facility. In one exemplary embodiment, motors connected to doors can open or close the doors. Sensors disposed with respect to storage receptacles can scan the storage volume of a storage container. The storage containers are movably disposed at one of the doors. The sensors can detect physical objects disposed in the storage volume of the storage receptacle and determine an amount of unoccupied space in the storage volume of the storage receptacle. The sensors can then transmit an indication of the determined unoccupied amount of space to a computing system that is configured to communicate with both the sensors and each motor of the doors. The computing system can receive the indication of the determined unoccupied amount of space and use the indication of unoccupied space to calculate a percentage of occupied storage volume in the storage receptacle. The computing system can then transmit a command to control the operation of the motor of the door at which the storage receptacle is disposed based on the calculated percentage so that a soon to be empty or full storage receptacle may then be quickly transported from the facility or the door may be shut while the storage receptacle is being loaded or unloaded.

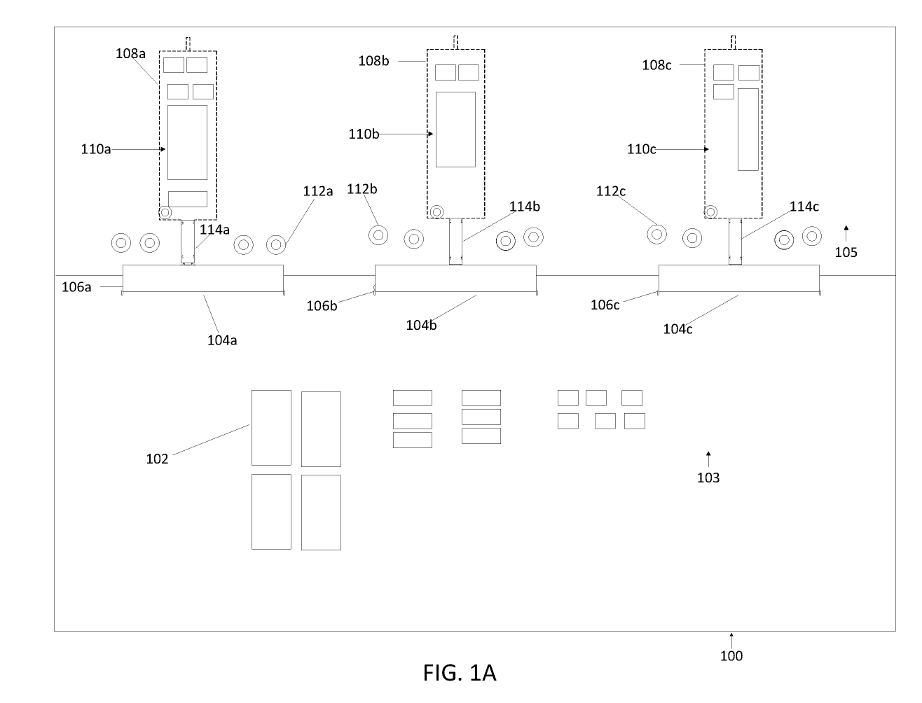

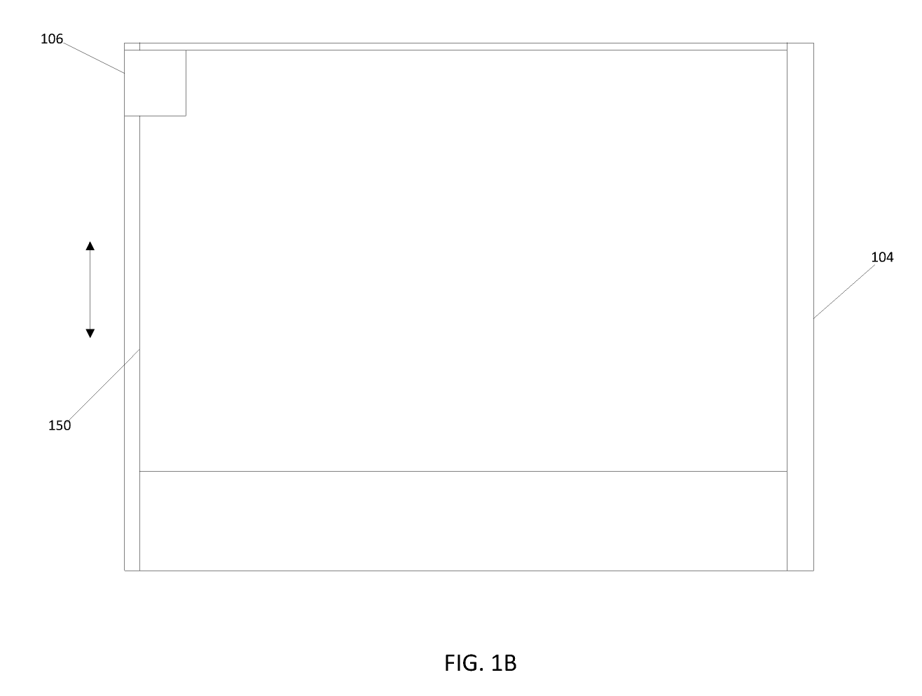

FIG. 1A is a block diagram of storage receptacles storing physical objects in a facility in accordance with an exemplary embodiment. In an exemplary embodiment, a facility 100 can include loading area 101. Physical objects 102 of various sizes can be disposed on a first side 103 the loading area and the loading area can include loading docks 104a, 104b, 104c. Each of the loading docks 104a, 104b, 104c can respectively include doors operated by motors 106a, 106b, 106c that control the operation of the door. As an example, the motors 106 can receive instructions to open or close the door from a computer system communicatively coupled to the motor.

Storage receptacles 108a, 108b, 108c can be disposed on a second side 105 of the loading area. The storage receptacles 108a, 108b, 108c are respectively docked at the loading docks 104a, 104b, 104c and can be aligned with the doors of the loading docks. The storage receptacles 108a, 108b, 108c have an interior storage volume 110a, 110b, 110c. The doors of the loading docks 104a, 104b, 104c can provide access to the interior storage volume 110a, 110b, 110c of the storage receptacles, when in an open position. For example, the interior storage volume 110a of a storage receptacle 108a can face the door of the loading dock 104a.

The physical objects 102 can be loaded into the interior storage volume 110 of the storage receptacles 108a, 108b, 108c docked at the loading docks 104a, 104b, 104c, through the door of the loading docks. In one example, the storage receptacles 108a, 108b, 108c may be directly coupled to the loading docks 104a, 104b, 104c. In another example, a ramp 114a, 114b, 114c can be respectively coupled to the storage receptacles 108a, 108b, 108c and the loading dock 104a, 104b, 104c, coupling the loading dock and the storage receptacle. One or more sensors 112a, 112b, 112c can be respectively disposed in the facility at one or more positions at which they may scan the interior storage volume 110a, 110b, 110c of the storage receptacles 108a, 108b, 108c. The sensors 112a, 112b, 112c may be located externally to the storage receptacles 108a, 108b, 108c in the facility. In one embodiment one or more of the sensors 112a, 112b, 112c may be located within the storage receptacles 108a, 108b, 108c. The storage receptacles 108a, 108b, 108c can be, but are not limited to, trailers, forklifts, storage containers and/or totes. The sensors 112a, 112b, 112c can be, but are not limited to, one or more of sonar sensors, laser sensors, video sensors, image sensors, LIDAR sensors and scales.

The sensors 112a, 112b, 112c can be configured to determine an amount of unoccupied space in the interior storage volume 110a, 110b, 110c of the storage receptacle 108a, 108b, 108c. The sensors 112a, 112b, 112c can respectively detect the physical objects within the interior storage volume 110a, 110b, 110c of the storage receptacles 108a, 108b, 108c. The sensors 112 can determine the unoccupied space based the detected physical objects 102. For example, the sensors 112a can scan the interior storage volume 110a of the storage receptacle 108a, which is docked at loading dock 104a. The sensors 112b can scan the interior storage volume 110b of the storage receptacle 108b, which is docked at loading dock 104b. The sensors 112c can scan the interior storage volume 110c of the storage receptacle 108c, which is docked at loading dock 104c. Different amounts of physical objects 102 and of various sizes can be disposed in the interior storage volumes 110a-c of the storage receptacles 108a-c.

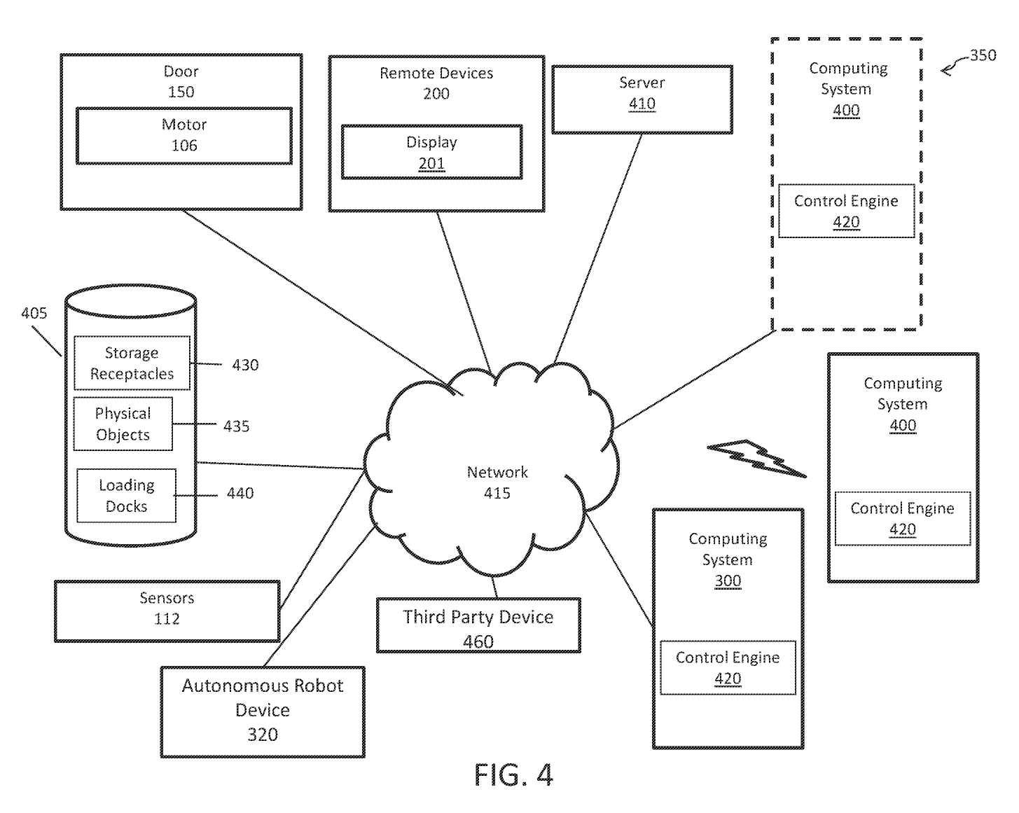

The sensors 112a-c can encode a detected amount of unoccupied space into electrical signals and transmit the electrical signals to a computing system. The computing system can use the detected amount of space to calculate a percentage of occupied storage volume based on the known size of the storage receptacle. The calculations can determine facility operations. For example, the computing system can determine the interior storage volume 110c of storage receptacle 108c has more unoccupied space than the interior storage volume 110b of storage receptacle 108b and schedule a transport for storage receptacle 108c before scheduling a transport for storage receptacle 108b. Similarly, the computing system can determine the interior storage volumes 110a-b of storage receptacles 108a-b have more unoccupied space than the interior storage volume of 110a of storage receptacle 108a. The computing system can further determine that the interior storage volume of 110a of storage receptacle 108a has less than a specified threshold of unoccupied space remaining. The computing system can also determine that the storage receptacle 102a has reached capacity and transmit instructions to the motor 106a controlling the operation of the door of the loading dock 104a, to close the door of the loading dock 104a. The computing system will be described further in detail with respect to FIG. 4.

It should be appreciated that while FIG. 1A depicts three loading bays, three ramps three storage receptacles with respective interior volumes and three sets of sensors, that depiction is for illustration and other numbers of loading bays, ramps storage receptacles and sets of sensors in greater or lesser amounts are within the scope of the present invention.

FIG. 1B is a block diagram of a door in a loading dock in a facility in accordance with an exemplary embodiment. As mentioned above, a loading dock 104 can include a motorized door 150. The door 150 can be coupled to a motor 106. The motor 106 can control the operation of a door. For example, the door 150 can be a roll-up door. The roll-up door can include horizontal slats that can roll up to keep the door 150 in an open position and roll down to keep the door 150 in a closed position and the motor 106 may connect to a pulley system used to open and close the door.

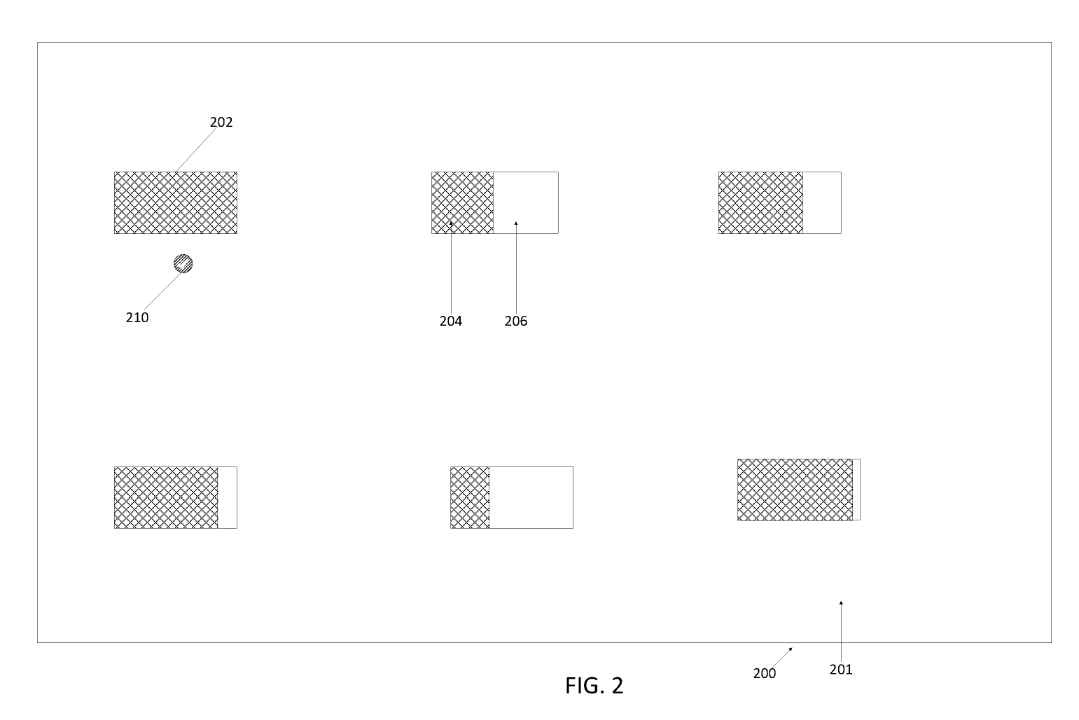

FIG. 2 illustrates a user interface of a remote system in accordance with an exemplary embodiment. A remote device 200 in communication with the computing system described herein (i.e.: a remote device in communication with the computing system that is communicating with the sensors and the motors in the facility) can include a display 201, and render a user interface illustrating a map of the loading docks in the facility based on the data received from the computing system. The remote device 100 may be a mobile device. The loading docks can be represented by the boxes 202. The boxes 202 can include a status bar. The status bar can indicate the level of completeness and/or fullness of the storage receptacles docked at a particular loading dock. For example the pattern 204 on the status bar can indicate the fullness of the storage receptacle. The pattern 206 can represent the unoccupied space in the storage receptacle. In response to the storage receptacle becoming completely full, an indicator 210 can appear with respect to the box 202.

The remote device 200 can receive input with respect to the boxes. The input can be transmitted to the computing system. The input can be associated with the operation of a door of a loading dock. In a non-limiting example the indicator 210 can be a selectable button. The remote device 200 can receive input associated with actuating the indicator 210. In response to actuating the indicator 210, the door of the loading dock associated with the box, can be opened or closed.

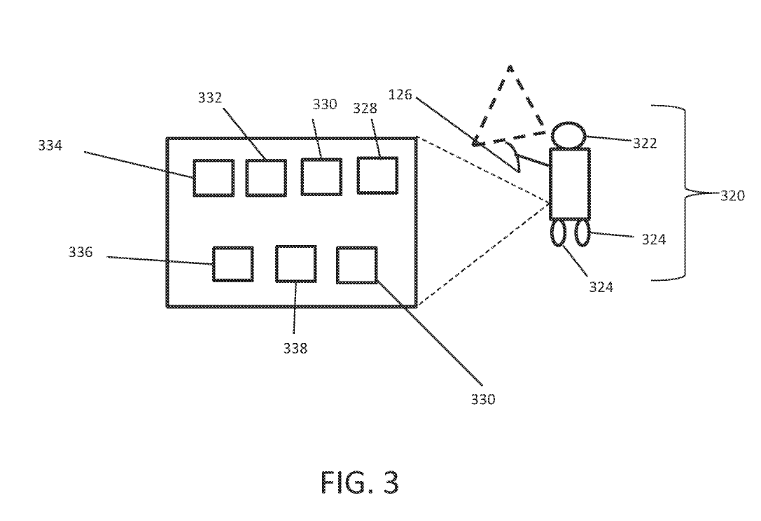

FIG. 3 is a block diagram illustrating an autonomous robot device according to exemplary embodiments of the present disclosure. The autonomous robot device 320 can be a driverless vehicle, an unmanned aerial craft, automated conveying belt or system of conveyor belts, and/or the like. Embodiments of the autonomous robot device 320 can include an image capturing device 322, motive assemblies 324, a picking unit 326, a controller 328, an optical scanner 330, a drive motor 332, a GPS receiver 334, accelerometer 336 and a gyroscope 338, and can be configured to roam autonomously through the facility (e.g. facility 100 as shown in FIG. 1A). The picking unit 326 can be an articulated arm. The autonomous robot device 320 can be an intelligent device capable of performing tasks without human control. The controller 328 can be programmed to control an operation of the image capturing device 322, the optical scanner 330, the drive motor 332, the motive assemblies 324 (e.g., via the drive motor 332), in response to various inputs including inputs from the GPS receiver 334, the accelerometer 336, and the gyroscope 338. The drive motor 332 can control the operation of the motive assemblies 324 directly and/or through one or more drive trains (e.g., gear assemblies and/or belts). In this non-limiting example, the motive assemblies 324 are wheels affixed to the bottom end of the autonomous robot device 320. The motive assemblies 324 can be but are not limited to wheels, tracks, rotors, rotors with blades, and propellers. The motive assemblies 324 can facilitate 360 degree movement for the autonomous robot device 320. The image capturing device 322 can be a still image camera or a moving image camera.

The GPS receiver 334 can be a L-band radio processor capable of solving the navigation equations in order to determine a position of the autonomous robot device 320, determine a velocity and precise time (PVT) by processing the signal broadcasted by GPS satellites. The accelerometer 336 and gyroscope 338 can determine the direction, orientation, position, acceleration, velocity, tilt, pitch, yaw, and roll of the autonomous robot device 320. In exemplary embodiments, the controller can implement one or more algorithms, such as a Kalman filter, for determining a position of the autonomous robot device.

In one embodiment, the autonomous robot device 320 can receive instructions from the computing system to navigate to a loading dock in the facility and control the operation of a motor. The instructions can include a location of the loading dock within the facility. The autonomous robot device can navigate can navigate through the facility using the motive assemblies 324 to the loading dock. The autonomous robot device 320 can be programmed with a map of the facility and/or can generate a map of the facility using simultaneous localization and mapping (SLAM). The autonomous robot device 320 can navigate around the facility based on inputs from the GPS receiver 328, the accelerometer 330, and/or the gyroscope 332.

In response to reaching the loading dock, the autonomous robot device 320 can control the operation of the motor of the door of the loading dock. For example, a button can be disposed at or around the loading dock. The button can control the opening or closing motor which can open or close the door of the loading dock. The autonomous device 320 can actuate the button using the picking unit 326. Alternatively, the autonomous robot device 320 can manually open or close the door using the picking unit 326. In one embodiment, the autonomous robot device 320 can detect the loading dock, the door and the button, using video analytics and/or machine vision.

FIG. 4 is a block diagram illustrating an automated routing system according to exemplary embodiments of the present disclosure. The automated storage receptacle processing system 450 can include one or more databases 405, one or more servers 410, one or more computing systems 400, one or more motors 106, one or more sensors 112, one or more remote devices 200, one or more automated robot devices 320, and one or more third party devices 460. The remote device 200 can include a display 201. In exemplary embodiments, the computing system 400 can be in communication with the databases 405, the server(s) 410, motors 106, sensors 112, remote devices 200, automated robot devices 320 and third party devices 460, via a communications network 415. The computing system 400 can implement at least one instance of a control engine 420. The control engine 420 can be an executable residing on the local computing system 400, configured to implement the automated storage receptacle processing system 450.

In an example embodiment, one or more portions of the communications network 415 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 400 includes one or more computers or processors configured to communicate with the conveyer belt motors 106, sensors 112, remote devices 200, automated robot devices 320 and third party devices 460, via a communications network 415. The computing system 400 hosts one or more applications configured to interact with one or more local components computing system 400 and/or facilitates access to the content of the databases 405. In some embodiments, the server 410 can host the control engine 420 or portions thereof. The databases 405 may store information/data, as described herein. For example, the databases 405 can include a storage receptacle database 430, a physical objects database 435 and a loading docks database 440. The storage receptacle database 330 can store information associated with storage receptacles. The physical objects database 335 can store information associated with physical objects. The loading docks database 440 can store information associate with loading docks. The databases 405 and server 410 can be located at one or more geographically distributed locations from each other or from the computing system 400. Alternatively, the databases 405 can be included within server 410.

In one embodiment, storage receptacles can be docked at loading docks at a facility. Doors 150 of the loading docks can provide access to interior storage volumes of the storage receptacles. The operation of the doors 150 can be controlled by motors 106. The doors 150 can be rolling overhead doors, configured roll up vertically to be in an open position and roll down vertically to be in a closed position. Sensors 112 can be disposed within and with respect to the storage receptacles. In one embodiment, a ramp can be coupled to the loading dock and the storage receptacle.

Physical objects can be loaded into storage receptacles through the doors 150. The sensors 112 can scan the interior storage volume of the storage receptacles. The sensors 112 can detect physical objects disposed in the interior storage volume of the storage receptacles and based on the detection of the physical object, the sensors 112 can detect an unoccupied amount of space in the interior storage volume of the storage receptacles. The sensors 112 can encode the detected unoccupied amount of space into electrical signals and transmit the electrical signals to the computing system 400.

The computing system 400 can receive the electrical signals from the sensors 112. The computing system 400 can execute the control engine 420 in response to receiving the electrical signals. The control engine 420 can decode the electrical signals to extract the detected unoccupied amount of space in a storage receptacle. The control engine 420 can query the storage receptacle database 430 to determine the size of the storage receptacle. The control engine 420 can calculate a percentage of unoccupied space in the storage receptacle based on the received unoccupied amount of space and the size of the storage receptacle.

In one embodiment, the control engine 420 can determine the percentage is below a specified threshold amount and in this regard, additional physical objects should not be loaded into the storage receptacle. The control engine 420 can determine the location of the storage receptacle. In one embodiment, the control engine 420 can determine the location of the storage receptacle based on the location of the sensors 112. In another embodiment, the location of the storage receptacle can be embedded in the electrical signals received from the sensors 112. The control engine 420 can query the loading docks database 440 to identify the loading dock at which the storage receptacle is docked based on the location of the storage receptacle. The control engine 420 can also identify the motor 106 coupled to the door 150 of the identified loading dock. The control engine 420 can transmit instructions to the identified motor 106, to close the door 150 of the loading dock, in response to determining the percentage of unoccupied space in the storage receptacle is below a specified threshold amount. Further, the control engine may transmit a message to a transport vehicle to move the container at the loading dock.

In one embodiment, in response to decoding the electrical signals to extract the unoccupied amount of space and identifying the storage receptacle, the control engine 420 can query the physical objects database 435 to determine which physical objects are designated to be deposited in the storage receptacle. The control engine 420 can determine whether the unoccupied amount of space is adequate to receive the physical objects designated to be deposited in the storage receptacle and have not yet been deposited. In response to determining, the unoccupied amount of space is adequate to receive the remaining physical objects, the control engine 420 may instruct the motor 106 of the loading dock at which the storage receptacle is docked, to maintain an open position of the door 150, even if the percentage of unoccupied space is below a threshold amount. Alternatively, in response to determining the unoccupied amount of space is not adequate to receive the physical objects designated to be deposited in the storage receptacle and have not yet been deposited and the percentage of unoccupied space is below a threshold amount, the control engine 420 may reassign the remaining physical objects to different storage receptacles.

In one embodiment, the control engine 420 can render a map of the loading docks on the display 201 of remote devices 200. In a non-limiting example, remote devices 200 may be a tablet, smartphone or other mobile computing device equipped with a display that is being operated by a facility employee. As mentioned above (with reference to FIG. 2), the map can include status bars indicating the amount of occupied and unoccupied space in a storage receptacle docked at the loading docks. The control engine 420 can update the status bars in response to determining a percentage based on the extracted unoccupied amount of space in a storage receptacle. In one embodiment, the control engine 420 can receive input from the remote device 200. The input can be associated with the operation of the door 150 of the loading dock. For example, the input can be instructions for closing the door 150 of a loading dock. The control engine 420 can instruct the motor 106 of the door 150 of the loading dock to close the door 150, in response to receiving instructions from the remote device 200. In another example, a new storage receptacle can dock at an unoccupied loading dock. The remote device 200 can transmit instructions to the control engine 420 to open the door 150 of the loading dock. The control engine 420 can instruct the motor 106 of the door 150 of the loading dock to open the door 150, in response to receiving instructions from the remote device 200.

In one embodiment, a ramp may be coupled to the storage receptacle and the loading dock. The ramp maybe used to load physical objects into the interior storage volume of the storage receptacle. The ramp may be operated by a motor 106. The motor 106 can be same motor which operates the door 150 of the loading dock. Alternatively, the motor 106 can be a different motor 106 coupled to the ramp. In response to the control engine 420 instructing the motor 106 to close the door 150 of a loading dock, the control engine 420 can also instruct the motor 106 to retract the ramp. The ramp can be retracted into the loading dock and/or into the storage receptacle. Alternatively, in response to instructing the motor 106 to open the door 150 of a loading dock, the control engine 420 can also instruct the motor 106 to extract the ramp, to couple with the loading dock and storage receptacle.

In one embodiment, the control engine 320 can instruct an autonomous robot device 320 to close the door 150 of a loading dock. The instructions can include a location of the loading dock. The location can be GPS coordinates. The autonomous robot device 320 can navigate to the loading dock and can operate the motor 106 of the door 150 to close the door. In some embodiments, the autonomous robot devices 320 can load the physical objects into the storage receptacles. Additionally, the control engine 320 can instruct the autonomous robot devices 320 to navigate to a loading dock, to control the motor 106 of a door 150 to open to door, in response to receiving a notification that a storage receptacle is about to be docked at the loading dock.

As a non-limiting example, the automated storage receptacle processing system 450 can be implemented in a retail store, warehouse and/or e-commerce distribution center. In one example, the storage receptacle can be a trailer configured to be coupled with a delivery vehicle. The physical objects can be products out for delivery to vendors and/or customers. In response to the control engine 420 instructing the motor 106 to close the door 150 of a loading dock, the control engine 420 can transmit a message to a remote device 200 alerting a delivery vehicle that a trailer is ready for delivery. The control engine 420 can also transmit an alert to a third party device 460 associated with a vendor and/or customer, at a delivery of the products is about to leave the warehouse/retail store.

In one embodiment, the storage receptacle can also be a pallet. The sensors 112 can be disposed with respect to the pallet. The sensors 112 can detect when the pallet is loaded and unloaded. When the pallet is unloaded the sensors 112 can transmit an electrical signal to the control engine 320. The unloaded pallet may indicate the completion of a loading or unloading process. The control engine 320 can decode the electrical signal and determine the completion of a loading or unloading process. The control engine 320 can identify the loading dock in proximity of the pallet. The control engine 320 can instruct the motor 106 of the door 150 of the identified loading dock to close the door 150.

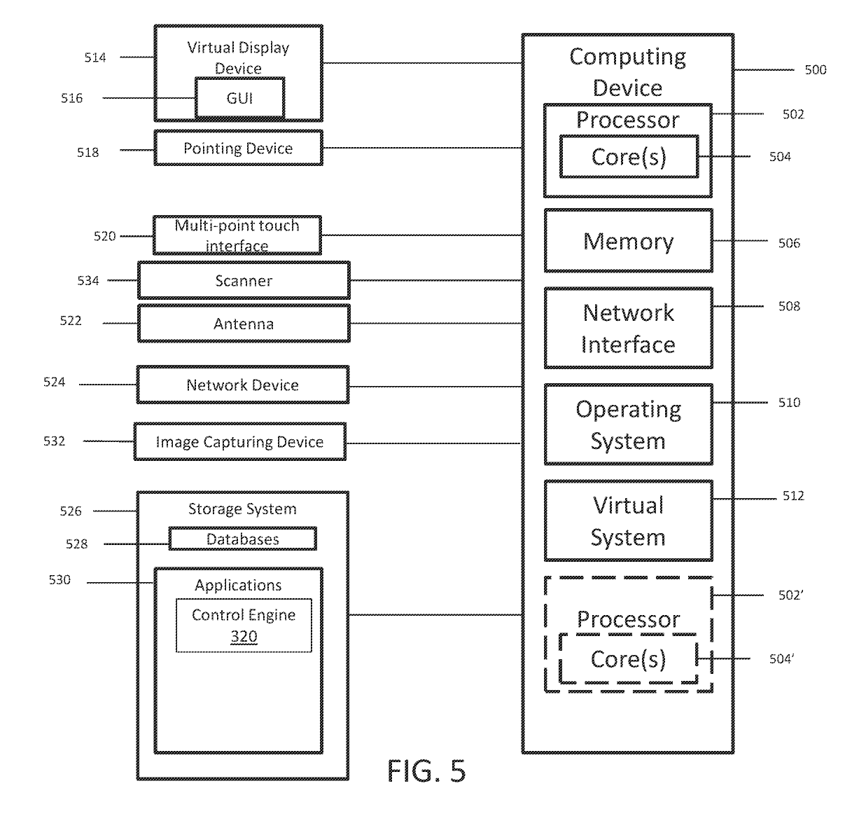

FIG. 5 is a block diagram of an exemplary computing device suitable for implementing embodiments of the automated storage receptacle processing system. The computing device may be, but is not limited to, a smartphone, laptop, tablet, desktop computer, server or network appliance. The computing device 500 can be embodied as part of the local computing system and/or terminal. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing device 500 may store computer-readable and computer-executable instructions or software (e.g., applications 530 such as the control engine 420) for implementing exemplary operations of the computing device 500. The computing device 500 also includes configurable and/or programmable processor 502 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for implementing exemplary embodiments of the present disclosure. Processor 502 and processor(s) 502′ may each be a single core processor or multiple core (504 and 504′) processor. Either or both of processor 502 and processor(s) 402′ may be configured to execute one or more of the instructions described in connection with computing device 500.

Virtualization may be employed in the computing device 500 so that infrastructure and resources in the computing device 500 may be shared dynamically. A virtual machine 512 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof. The computing device 500 can receive data from input/output devices such as, a reader 534 and an image capturing device 532.

A user may interact with the computing device 500 through a visual display device 514, such as a computer monitor, which may display one or more graphical user interfaces 516, multi touch interface 520 and a pointing device 518.

The computing device 500 may also include one or more storage devices 526, such as a hard-drive, CD-ROM, or other computer readable media, for storing data and computer-readable instructions and/or software that implement exemplary embodiments of the present disclosure (e.g., applications 530 such as the control engine 420). For example, exemplary storage device 526 can include one or more databases 528 for storing information such as information associated with storage receptacles, loading docks and physical objects. The databases 528 may be updated manually or automatically at any suitable time to add, delete, and/or update one or more data items in the databases.

The computing device 500 can include a network interface 508 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 522 to facilitate wireless communication (e.g., via the network interface) between the computing device 500 and a network and/or between the computing device 500 and other computing devices. The network interface 508 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

The computing device 500 may run any operating system 510, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 500 and performing the operations described herein. In exemplary embodiments, the operating system 510 may be run in native mode or emulated mode. In an exemplary embodiment, the operating system 510 may be run on one or more cloud machine instances.

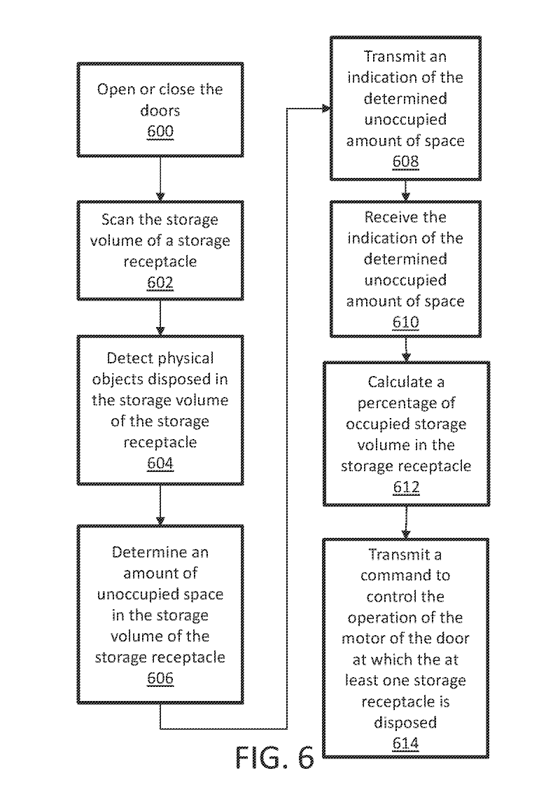

FIG. 6 is a flowchart illustrating an exemplary process in accordance with exemplary embodiments of the present disclosure. In operation 600, doors (e.g. door 150 as shown in FIGS. 1B and 4) may be equipped with motors (e.g. motor 106 as shown in FIGS. 1A-B and 4) to open or close the doors. In operation 602, sensors (e.g. sensors 112 as shown in FIGS. 1A and 4) disposed with respect to storage receptacles having storage volume to store physical objects (e.g. physical objects 102 as shown in FIG. 1A) can scan the storage volume of a storage receptacle (e.g. (e.g. storage volume 110 as shown in FIG. 1A and storage receptacle 108 as shown in FIG. 1A). The storage receptacles are movably disposed at one of the doors. In operation 604, the sensors can detect physical objects disposed in the storage volume of the storage receptacle. In operation 606, the sensors can determine an amount of unoccupied space in the storage volume of the storage receptacle.

In operation 608, the sensors can transmit an indication of the determined unoccupied amount of space to a computing system (e.g. computing system 300 as shown in FIG. 3) in communication with the sensors and also in communication with each motor of the doors. In operation 610, the computing system can receive the indication of the determined unoccupied amount of space. In operation 612, the computing system can calculate a percentage of occupied storage volume in the storage receptacle based on the determined unoccupied amount of space. In operation 614, the computing system can transmit a command to control the operation of the motor of the door at which the at least one storage receptacle is disposed based on the calculated percentage.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A system for automated storage receptacle processing in a facility, comprising:
a plurality of doors, each door equipped with a motor configured to open and close the door;
a plurality of storage receptacles, each storage receptacle movably disposed at one of the doors and including a storage volume to store one or more physical objects;
a plurality of sensors disposed with respect to the plurality of storage receptacles, at least one of the plurality of sensors configured to:
scan the storage volume of at least one the plurality of storage receptacles;
detect one or more physical objects disposed in the storage volume of the at least one storage receptacle;
determine an unoccupied amount of space in the storage volume of the at least one storage receptacle;
transmit an indication of the determined unoccupied amount of space to a computing system in communication with the at least one sensor; and
the computing system in communication with the at least one sensor and also in communication with each motor of the plurality of doors, the computing system configured to:
receive the indication of the determined unoccupied amount of space;
calculate a percentage of occupied storage volume in the at least one storage receptacle based on the determined unoccupied amount of space; and
transmit a command to control the operation of the motor of the door at which the at least one storage receptacle is disposed based on the calculated percentage.

2. The system of claim 1, wherein the calculated percentage equals or exceeds a predetermined threshold and the command causes the motor to open the door.

3. The system of claim 2, wherein the computing system automatically transmits a message to a vehicle configured to move the storage receptacle.

4. The system of claim 1, wherein the calculated percentage equals or is less than a predetermined threshold and the command causes the motor to close the door.

5. The system of claim 1, further comprising one or more remote devices in communication with the computing system, each remote device including a display, at least one remote device configured to:
render a graphical user interface (GUI);
render a map of the plurality of storage receptacles in the facility on the GUI; and
display an indicator on the GUI selectable to control the operation of the motor of the door at which the at least one storage receptacle is disposed.

6. The system of claim 5, wherein the at least one remote device is further configured to:
receive input associated with a second one of the plurality of storage receptacles; and
transmit the input to the computing system, the input controlling the operation of the motor of the door at which the second one of the plurality of storage receptacles is disposed.

7. The system of claim 1, wherein the plurality of storage receptacles are one or more of: trailer, forklift, storage container, or tote.

8. The system of claim 1, further comprising a ramp disposed in an extended position, coupled to the at least one storage receptacle, wherein the motor controls the operation of the ramp based on the calculated percentage.

9. The system of claim 1, wherein the plurality of sensors are one or more of: sonar sensor, laser sensor and scales.

10. The system of claim 1, wherein the plurality of sensors are configured to be disposed outside or inside each of the plurality of storage receptacles.

11. A method for automated processing of storage receptacles, the method comprising
opening and closing, via a motor equipped with each of a plurality of doors, the door;
scanning, via at least one of a plurality of sensors disposed with respect to a plurality of storage receptacles, each storage receptacle movably disposed at one of the doors and including a storage volume to store one or more physical objects, the storage volume of at least one the plurality of storage receptacles;
detecting, via the at least one of the plurality of sensors, one or more physical objects disposed in the storage volume of the at least one storage receptacle;
determining, via the at least one of the plurality of sensors, an unoccupied amount of space in the storage volume of the at least one storage receptacle;
transmitting, via the at least one of the plurality of sensors, an indication of the determined unoccupied amount of space to a computing system in communication with the at least one sensor and also in communication with each motor of the plurality of doors;
receiving, via the computing system, the indication of the determined unoccupied amount of space;
calculating, via the computing system, a percentage of occupied storage volume in the at least one storage receptacle based on the determined unoccupied amount of space; and
transmitting, via the computing system, a command to control the operation of the motor of the door at which the at least one storage receptacle is disposed based on the calculated percentage.

12. The method of claim 11, wherein the calculated percentage equals or exceeds a predetermined threshold and the command causes the motor to open the door.

13. The method of claim 12, further comprising automatically transmitting, via the computing system, a message to a vehicle configured to move the storage receptacle.

14. The method of claim 11, wherein the calculated percentage equals or is less than a predetermined threshold and the command causes the motor to close the door.

15. The method of claim 11, further comprising:
rendering, via at least one of a plurality of remote devices in communication with the computing system, each remote device including a display, a graphical user interface (GUI);
rendering, via the at least one remote device, a map of the plurality of storage receptacles in the facility on the GUI; and
displaying, via the at least one remote device, an indicator on the GUI selectable to control the operation of the motor of the door at which the at least one storage receptacle is disposed.

16. The method of claim 15, further comprising:
receiving, via the at least one remote device, input associated with a second one of the plurality of storage receptacles; and
transmitting, via the at least one remote device, the input to the computing system, the input controlling the operation of the motor of the door at which the second one of the plurality of storage receptacles is disposed.

17. The method of claim 11, wherein the plurality of storage receptacles are one or more of: trailer, forklift, storage container, or tote.

18. The method of claim 11, further comprising controlling, via the motor, a ramp disposed in an extended position, coupled to the at least one storage receptacle, the operation of the ramp based on the calculated percentage.

19. The method of claim 11, wherein the plurality of sensors are one or more of: sonar sensor, laser sensor and scales.

20. The method of claim 11, wherein the plurality of sensors are configured to be disposed outside or inside each of the plurality of storage receptacles.
